(19) United States
(12) Patent Application Publication
(10) Pub. No.: US 2024/0051795 A1
(43) Pub. Date: Feb. 15, 2024

(54) ELEVATOR CAR FOR AN ELEVATOR SYSTEM AND INSTALLATION METHOD FOR INSTALLING AN ELEVATOR SYSTEM

(71) Applicant: Inventio AG, Hergiswil (CH)

(72) Inventor: Christoph Schuler, Rotkreuz (CH)

(21) Appl. No.: 18/257,886

(22) PCT Filed: Dec. 16, 2021
(86) PCT No.: PCT/EP2021/086221

§ 371 Date: Jun. 16, 2023

(30) Foreign Application Priority Data
Dec. 23, 2020 (EP) 20217066.8

(51) Int. Cl. B66B 11/02; B66B 19/04

(52) U.S. Cl. CPC B66B 11/0226; B66B 19/04

(57) ABSTRACT

An elevator car has a foldable car floor including two floor segments that are connected to each other via a pivot axis. The car floor is introduced into an elevator shaft in an initial position in which the floor segments are folded together, and is then folded out. Once folded out, the car floor is in its final position. The elevator car can now be completed with car side walls and a car ceiling being mounted on the completely folded out car floor.

### FIELD

The invention relates to elevator car for an elevator system, an elevator car floor and an installation method for installing an elevator system.

### BACKGROUND

Elevator systems for conveying people and goods contain elevator cars that can be moved up and down in an elevator shaft. The cars can be moved by means of a drive unit via suspension means, for example in the form of suspension cables or suspension belts. Elevator cars comprise a car floor, car side walls and ceiling, and usually at least one car door. Elevator cars, for example, are installed in car frames, which in turn are guided by rails fastened in elevator shafts and moved by the drive units. However, there are also self-supporting elevator cars that do not require a car frame. The car floor must normally support the weight of the car superstructure with car side walls, roof, car doors and various fixtures, as well as the entire maximum payload. An elevator car of comparable type has become known, for example, from EP 1 004 538 B1. The car floor is of composite or sandwich construction and consists substantially of two steel plates spaced apart from one another, between which a support structure with a plurality of intersecting flat profiles is arranged. The car floor is heavy and bulky, and therefore difficult to handle. It is correspondingly difficult to transport the car floor within a building, maneuver it through narrow spaces and bring it into the elevator shaft through shaft openings.

The transport problem can be solved by dividing the car floor into several separate modular parts and transporting them in this manner. At the installation site of the elevator system, the separate individual parts must be connected to one another by means of screw connections. Screwing the car floor to create its final position is comparatively demanding and time-consuming.

### SUMMARY

It is therefore an object of the present invention to avoid the disadvantages of the known and, in particular, to provide an elevator car that is optimized with respect to transportation to the installation site and installation.

The object is solved by an elevator car having the features described below. The elevator car comprises a foldable car floor. When the car floor is in a final position, the elevator car or elevator system is ready for operation. The fact that the car floor can be folded offers numerous advantages. The handling of the car floor is improved. The car floor can be transported in a scaled-down form and maneuvered in the building where the elevator shaft is located. Since the car floor can be folded as a whole, the installation effort can be reduced considerably. In particular, there is no need to laboriously connect and fix individual components of the floor.

The foldable car floor can be opened from an initial position to the aforementioned final position. The final position corresponds to a position in which the car floor is preferably fully opened. In other words, in the final position, the car floor is spread out flat in a planar position to form the walking or use area for passengers or goods in the car. In the initial position, the car floor can be folded. The initial position is preferably the position in which the car floor is delivered from the factory, transported and placed in the elevator shaft or other installation location. The initial position thus corresponds to a type of pre-installation position. The folded car floor is reduced in size compared to the unfolded car floor in the final position and requires less space.

The car floor may have the shape of a rectangle in plan view. The sides of the rectangle can correspond approximately to the width and depth of the elevator car. In the final position, the car floor can cover the entire floor surface of the car floor; in the initial position, the car floor can cover only a part of the floor surface of the car floor.

Preferably, the car floor is constructed of two floor segments hingedly connected to one another, wherein the floor segments extend over the entire car width or car depth. The car floor thus consists of few coherent components, which has a favorable effect on handling and installation.

It can be particularly advantageous if the car floor consists of two floor segments connected by a pivot axis. The car floor thus consists of only two coherent parts. A two-part car floor of this type, wherein the respective parts are formed by the floor segments, can be easily transported in the folded state (initial position) and can be unfolded particularly easily, namely by a single pivoting movement to create the final position. The floor segment can form one half of the floor at a time, which is why the floor segment could also be referred to as a car floor half.

In a further embodiment, the at least two floor segments may each have flat floor portions, preferably formed by metal sheets, for predefining the walking or use surface. Passengers or goods can directly impact the access surface. Of course, indirect impact is also conceivable. A cover plate can be placed over the adjacent floor portions in the final position, for example, for decorative purposes.

The car floor may have at least two floor segments interconnected by a pivot axis, wherein the pivot axis is positioned within one of the floor segments. The pivot axis is thus not arranged on the edge side but offset inwardly with respect to an edge of the floor segment, such that the pivot axis is positioned or arranged within one of the floor segments with respect to the top view of the car floor. With such an arrangement, it can be achieved that the car floor in the final position can meet high requirements in terms of stability and flexural rigidity.

A further embodiment relates to an elevator car with a car floor that has a first floor segment and a second floor segment hinged to the first floor segment via a pivot axis. Here, the pivot axis is positioned within the first floor segment. The second floor segment may have a planar floor portion and at least two hinged arms by which the second floor segment is hingedly connected to the first floor segment.

To increase stability, it is advantageous if the second floor segment is connected to the first floor segment in such a manner that the hinged arms of the second floor segment rest against or are supported by the first floor segment in the final position.

The hinged connection can preferably be formed by a pivot.

Locking means can be provided to secure the position of the car floor in the final position. For example, the foldable car floor can be configured in such a manner that, when the car floor is in the final position, further folding up is made impossible by appropriate locking means (for example, the aforementioned lever elements supported on the floor portion).

For a stable connection between the two floor segments, it is advantageous if more than three and preferably more than five hinged arms are provided.

The at least two floor segments may contain longitudinal ribs extending at right angles to the pivot axis to form a stiffening arrangement. In addition to the longitudinal ribs, the respective floor segments may also contain transverse ribs extending parallel to the pivot axis. The transverse and longitudinal ribs can thus form a grating-like structure. The longitudinal ribs can, for example, be welded to the respective flat floor portions. However, the ribs can also be sheet metal profiles with an L or Z shape, screwed, riveted or otherwise fastened to the floor portions. Of course, other profile shapes for the ribs are also conceivable.

The two hinged arms can each connect to longitudinal ribs and thus form an integral part of the stiffening arrangement.

A further aspect of the invention relates to a car floor for the elevator car described above.

Finally, a further aspect of the invention relates to an installation method for installing an elevator system, wherein the elevator system comprises in particular the elevator car described above. The installation method is characterized by the following steps: providing a foldable car floor for the elevator car, inserting the folded car floor into an elevator shaft or, as the case may be, into or at another installation location, unfolding the car floor inserted into the elevator shaft, and completing the elevator car, wherein car side walls and a car ceiling are mounted to the car floor. Of course, car doors and other components of the car can be mounted as required.

In procedural terms, it may be further advantageous if the collapsed car floor is lowered from or to an erected position, for example a more or less vertical location, wherein the partially unfolded car floor has the shape of an inverted “V” when lowered. A car floor placed in this manner cannot be folded up or down any further when it reaches the final position. The position of the car floor can thus be secured in the final position if appropriate locking means are provided.

### DESCRIPTION OF THE DRAWINGS

Further individual features and advantages of the invention can be derived from the following description of embodiments and from the drawings. In the drawings:

FIG. 1 shows a highly simplified perspective view of an elevator with an elevator car,

FIG. 2 shows a highly simplified view of a folded car floor for an elevator car according to the invention (initial position),

FIG. 3 shows the car floor from FIG. 1 after it has been unfolded (final position),

FIG. 4 shows a perspective view of a car floor in an initial position,

FIG. 5 shows a partially unfolded car floor during a depositing operation, and

FIG. 6 shows the car floor in the final position.

### DETAILED DESCRIPTION

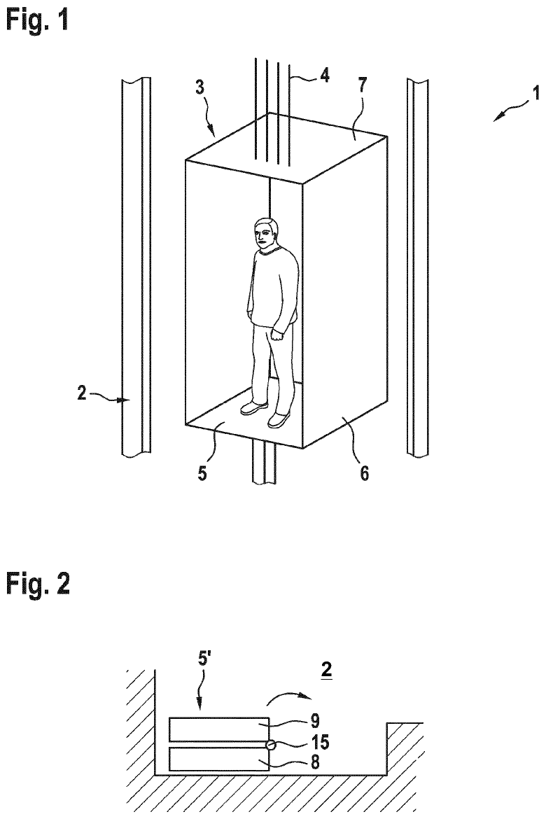

FIG. 1 shows an elevator system designated 1 with an elevator car 3 fastened to suspension means 4. The elevator shaft is shown suggestively and marked 2. Such or similar elevator systems have been known and used for a long time. Vertical side walls 6 adjoin a car floor 5; the elevator car 3 is closed by a ceiling 7. In FIG. 1, the elevator car 3 is simplified and only exemplarily directly connected to the suspension means 4, which can be, for example, wire cables or suspension belts. Other suspension concepts, such as looping the elevator car underneath with suspension means, are of course also conceivable. The elevator car 3 can be configured as a self-supporting elevator car or as an elevator car with a car frame. In the following, the car floor 5, which is characterized by a special structure and properties, is described in detail.

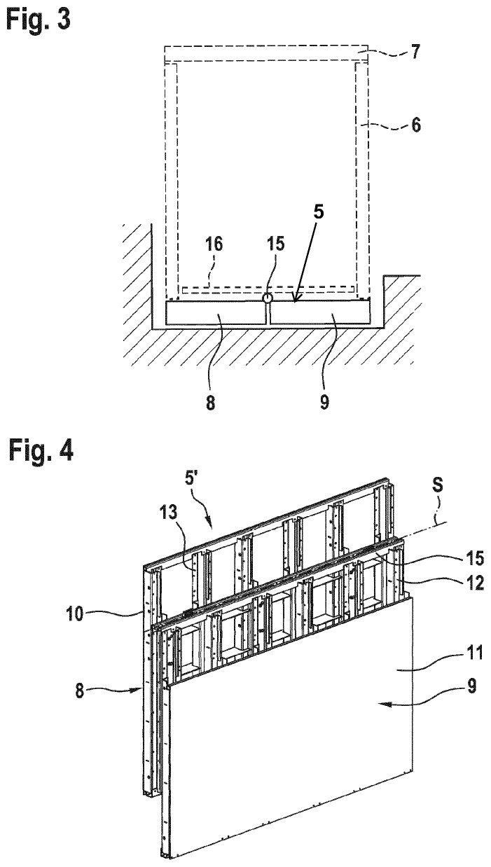

FIGS. 2 and 3 show a first embodiment of a foldable car floor 5 for the elevator system 1. FIG. 2 shows the car floor 5 designated 5′ when in an initial position. In this position, the car floor 5 is folded. The car floor 5 consists of two floor segments 8 and 9, which are connected to one another by a hinge 15, preferably in the form of a pivot.

As can be seen from FIG. 2, the folded car floor, marked 5′, is initially stored in the shaft pit of elevator shaft 2 in the initial position. The two floor segments 8, 9 are each aligned horizontally in this position in vertically spaced planes.

To create the end location, the upper floor segment 9 is transferred to a flat position in a pivoting movement indicated by an arrow, such that the floor segment 9 is next to the first floor segment 8 and is flush with it. The end location has now been reached and the car floor 5 is fully opened. The car floor 5 is spread out in a common plane to form the passenger walking area in the car. This final position is shown in FIG. 3.

Now the car side walls 6 and the ceiling 7 can be attached to the car floor 5. If necessary, a decorative plate 16 can be stored on the car floor 5.

The folded car floor 5′ takes up little space and is easy to transport. In particular, the folded car floor 5′ can be easily and efficiently transported within a building and maneuvered through narrow spaces. In particular, compared with conventional car floors, which are at least twice as large and therefore correspondingly bulky, it is easier to bring the car floor, which has been reduced in size by folding, through shaft openings into the elevator shaft.

In the embodiment example in accordance with FIGS. 2 and 3, the two floor segments 8 and 9 each correspond to car floor halves. The joint 15 is arranged at the edge of the floor segments 8, 9.

FIGS. 4 to 6 below show a further variant of a folding car floor 5. The foldable car floor 5 consists of two hinged floor segments 8 and 9, wherein the pivot axis is not arranged at the edge but inside one of the floor segments. The pivot axis marked S is located within the first floor segment marked 8. The second floor segment 9 comprises a planar floor portion 11 and hinged arms 12. The hinged arms 12 form the connection of the second floor segment 9 to the first floor segment 8.

Both floor segments 8, 9 each have flat floor portions 10, 11 respectively which, when the car floor 5 is fully unfolded to create the final position and stored on the shaft floor for further car assembly or positioned at another height in the elevator shaft 2, lie on a horizontal plane. The floor portions 10, 11 may be formed by sheet metal blanks. Side wall portions created by folding or bending processes can subsequently adjoin the floor portions 10, 11 at the edges.

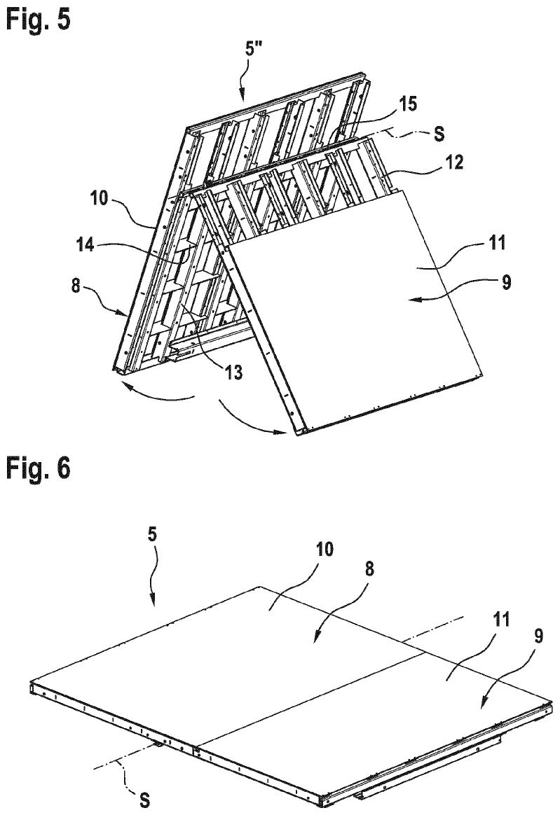

As can be seen from the present embodiment and in particular from FIG. 5, six hinged arms 12 are provided. However, fewer and possibly even more hinged arms would also be conceivable. The car floor 5 further has longitudinal ribs 13 and transverse ribs 14 arranged on the undersides of the floor portions 10, 11. These longitudinal ribs 13 and transverse ribs 14 form a stiffening arrangement for stiffening the respective floor portions 10, 11 and for stiffening the car floor 5. The hinged arms 12 can be formed by the longitudinal ribs 13 that are elongated with respect to the floor portion 11. The hinged arms 12 thus connect to the longitudinal ribs and are an integral component of the stiffening arrangement at least in the end location.

The car floor 5 is configured in such a manner that it is folded up in the initial position designated 5′ in FIG. 4. In this position, the foldable car floor 5 is delivered from the factory, transported and moved to the shaft or other installation location.

The installation procedure for installing the elevator system 1 comprises the following steps: First, the foldable car floor 5 must be provided. The folded car floor 5′ is brought into the elevator shaft 2. From a vertical location (FIG. 4), the car floor is stored and unfolded at the same time. In FIG. 5, the car floor labeled 5″ here is in an intermediate position before reaching the final position shown in FIG. 6. FIG. 5 shows that the partially opened car floor 5″ has the shape of an inverted “V” when stored. As soon as the car floor 5 is completely unfolded (FIG. 6), the completion of the elevator car 3 can be continued, wherein the car side walls and the car ceiling as well as car doors and various fixtures are mounted to the car floor 5 as required.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. An elevator car for an elevator system, the elevator car comprising a car floor foldable between an initial position and a final position, and when the car floor is in the final position the car floor is adapted to adjoin vertical side walls of the elevator car.

17. The elevator car according to claim 16 wherein the car floor is adapted to be folded up into the initial position and unfolded into the final position.

18. The elevator car according to claim 16 wherein the car floor includes two floor segments that are aligned horizontally in respective vertically spaced planes when the car floor is in the initial position.

19. The elevator car according to claim 16 wherein the floor segments are hingedly connected to one another, and the floor segments are sized to extend over an entire width of the elevator car and/or an entire depth of the elevator car when unfolded into the final position.

20. The elevator car according to claim 16 wherein the floor segments are connected to one another via a pivot axis.

21. The elevator car according to claim 16 wherein each of the floor segments has flat floor portions forming a walking or use area when the floor segments are in the final position.

22. The elevator car according to claim 16 wherein the floor segments are interconnected by a pivot axis and the pivot axis is positioned within one of the floor segments.

23. The elevator car according to claim 16 wherein the floor segments are a first floor segment and a second floor segment articulated to the first floor segment by a pivot axis, wherein the pivot axis is positioned within the first floor segment and wherein the second floor segment includes a flat floor portion and at least two hinged arms, the at least two hinged arms hingedly connecting the second floor segment to the first floor segment.

24. The elevator car according to claim 23 wherein the at least two hinged arms rest on or are supported against the first floor segment when the first and second floor segments are in the final position.

25. The elevator car according to claim 23 wherein the second floor segment includes more than three of the hinged arms.

26. The elevator car according to claim 23 wherein the second floor segment includes more than five of the hinged arms.

27. The elevator car according to claim 16 wherein the floor segments are connected to one another via a pivot axis, the floor segments each containing longitudinal ribs extending at right angles to the pivot axis and stiffening the car floor.

28. The elevator car according to claim 27 including at least two hinged arms connected to the longitudinal ribs and further stiffening the car floor.

29. An installation method for installing an elevator system having an elevator car according to claim 16, the method comprising the following steps:
providing the foldable car floor;
inserting the foldable car floor folded in the initial position into an elevator shaft or another installation location of the elevator system;
orienting the foldable car floor with the floor segments in vertical planes and partially unfolding the foldable car floor to an intermediate position at a storage location; and
unfolding the foldable car floor from the intermediate position to the final position and completing the elevator car by mounting car side walls and a car ceiling to the foldable car floor in the final position.

30. The installation method according to claim 29 wherein that the folded car floor has an inverted “V” shape when in the intermediate position.

31. A car floor for an elevator car, the car floor comprising:
a first floor segment;
a second floor segment connected to the first floor segment; and
wherein first and second floor segments are movable relative to one another between a folded initial position and a final position, and when the floor segments are in the final position the car floor is adapted to adjoin vertical side walls to form an elevator car.

32. The car floor according to claim 31 wherein the first and second floor segments are hingedly connected to one another and are sized to extend over an entire width of the elevator car and/or an entire depth of the elevator car when unfolded into the final position.

33. The car floor according to claim 31 wherein the first and second floor segments are interconnected by a pivot axis and the pivot axis is positioned within the first floor segment and wherein the second floor segment includes at least two hinged arms, the at least two hinged arms hingedly connecting the second floor segment to the first floor segment at the pivot axis.
